(19) United States
(12) Patent Application Publication
(10) Pub. No.: US 2026/0112550 A1
(43) Pub. Date: Apr. 23, 2026

(54) FABRICATING AN ELECTRODE FOR A LITHIUM-ION CAPACITOR

(71) Applicant: NANOCAPS AS, Borre (NO)

(72) Inventor: Per Alfred ØHLCKERS, Nesbru (NO)

(21) Appl. No.: 19/117,054

(22) PCT Filed: Sep. 21, 2023
(86) PCT No.: PCT/NO2023/060052

§ 371 Date: Mar. 30, 2025

(30) Foreign Application Priority Data
Sep. 30, 2022 (NO) 20221045

(51) Int. Cl. H01G 11/86; C23C 28/00; H01G 11/50

(52) U.S. Cl. CPC H01G 11/86; C23C 28/32; C23C 28/34; H01G 11/50

(57) ABSTRACT

Method for fabricating an electrode pair for a Lithium-Ion Capacitor (LIC), where the method comprises the steps of preparing the positive electrode by, etching microstructures with a predetermined roughness in a surface of a metal film substrate, depositing in said microstructures a metal or metal compound layer, converting said metal or metal compound layer into metal nanoparticles, growing interconnected cross linked carbon nanotubes in said microstructures at said metal nanoparticle, and preparing the negative electrode.

### BACKGROUND

Lithium-ion batteries (LIBs) and supercapacitors (SCs) are well-known energy storage devices. However, both devices are inadequate for many applications. Lithium-ion capacitors (LICs) are combinations of LIBs and SCs which improve the performance by bridging the gap between these two devices.

LIC is a combination of high power electric double layer capacitor (EDLC) type positive electrode and high energy lithium insertion/desertion type negative electrode with Li-based organic electrolyte. Amatucci et al. have introduced the pioneering concept of hybrid LIC by using nanostructured Li4Ti5O12 (LTO) negative electrode and activated carbon (AC) positive electrode. Different electrodes have been proposed to be promising components of the LICs. Most of the research and patenting is targeting the improvement of the electrode performance by using different synthesis strategies.

The charge/discharge process of the LICs involves faradaic and non-faradaic electrochemical reactions. During charging, Li-ions are intercalated in the negative electrode materials and anions are adsorbed on the surface of AC positive electrode, while during discharging, the reverse process takes place.

LTO and graphitic electrode have been used mostly in the LICs. The negative electrode of the LICs is basically intercalation type battery material however, to employ it in the LICs, one may need to slightly incline their properties towards capacitor by designing hybrid electrode materials. The hybrid materials can be prepared using capacitive and battery type storage mechanisms.

Typically, activated carbon (AC) has been used as an electrode in an LIC which provides power performance by exploiting capacitive EDLC type adsorbing/de-adsorbing electrode. The very nature of AC is its porosity which has a surface area larger than 1000 m2/g. The specific capacitive performance of AC depends on the surface area, the pore volume, and the pore size distribution.

Another electrode material for Lithium-Ion-Capacitors are Carbon nanotubes (CNTs). Carbon nanotubes deriving from the development of nanoscience and nanotechnology, possess unique properties, such as extraordinary mechanical, excellent electrical conductivity, and nanoscale sizes making them suitable for a promising application in the field of energy storage. A typical method for a CNTs layer synthesized by chemical vapor deposition (CVD) is using Fe nanoparticles as the catalysts which are deposited on a barrier layer of Al₂O₃ or SiO₂. However, there are several drawbacks associated with such a CNT layers for supercapacitor applications. First, the existence of a barrier increases the contact resistance between the CNTs layer and the current collector. Second, this CNTs layer perpendicular to the substrate, which is a loose structure with a small mass density that is not beneficial to improve the energy density of supercapacitors.

Other examples of the prior art are discussed in WO2008/048347 where aligned nanostructures are provided on a surface, where the surface has been patterned to provide catalyst island where the nanotubes as grown. WO2005/065425 presents a method for initiating nanostructure growth where a catalyst is deposited on a resistive element prior to a heating process. CN108217628 describes a method for making a three-dimensional network of nanotubes from an alumina template, such as a through hole, containing nickel sulfate particles, where the nanotubes are upright relative to the surface and includes further nanotubes linking the upright nanotubes.

Pai Lu et al. reported a method to synthesize a carbon nanotube film on etched silicon for on-chip supercapacitor (Pub. No.: US 2020/001356A1). Silicon is a good candidate substrate to develop on-chip supercapacitor due to compatible with integrated circuits chip manufacturing. However, the silicon substrate is not flexible, and more expensive and poor conductivity comparing to metal film substrates.

Additionally, to the performances of the individual electrode materials, the mass balance between positive and negative electrodes also plays a key role on the electrochemical performance of the LICs. The mass balance allows controlling electrochemical performance in terms of specific capacity, cycling stability and degree of utilization of each electrode and is the key to achieve a high energy density with high cycle life without compromising the power density.

Relatively large iCL-CNT electrodes (described below) will give greater power capacity but lower energy, and the opposite with relative larger Li-ion electrodes.

Pre-lithiation is a crucial stage for making LICs, its great cost and process difficulty have seriously hindered the commercialization of LICs. Therefore, there is a need for improving the reliable and scalable method for pre-lithiation or to remove the need for the pre-lithiation step.

### SUMMARY OF THE INVENTION

### Therefore, the Objects of the Present Invention Are to Solve the Above-mentioned problems and to provide

a) an electrode pair, in particular a Lithium-Ion capacitor electrode pair.
b) a method for making an electrode pair, in particular a Lithium-Ion capacitor electrode pair
c) a Lithium-Ion capacitor, using a Lithium-Ion electrode as negative electrode with an iCL-CNT electrode on a metal substrate as positive electrode.
d) a method for making a Lithium-Ion capacitor, using a Lithium-Ion electrode as negative electrode with an iCL-CNT electrode on a metal substrate as positive electrode.

The objects of the invention are solved by the methods, electrodes, and capacitors as defined in the claims.

In detail:
a) According to the invention an electrode pair for a Lithium-Ion Capacitor (LIC) is provided—a Lithium-Ion electrode as negative electrode and an iCL-CNT electrode as positive electrode. The iCL-CNT electrode comprises metal microstructures on a metal film substrate (current collector), deposited metal nanoparticles and interconnected cross-linked carbon nanotubes (iCL-CNT). A schematic drawing of the material of the iCL-CNT electrode is shown in FIG. 1.
b) According to the invention a method for making an electrode pair for a LIC-electrode is provided. The method comprises making a Lithium-Ion electrode and an iCL-CNT electrode. Making the iCL-CNT electrode comprises the steps of forming the microstructures on the surface of a metal film substrate, coating the microstructured substrate with a metal layer or metal compounds which can convert into metal nanoparticles by subsequent heat treatment in a reducing gas atmosphere, and growing the cross-linked carbon nanotubes on the microstructured substrate under the catalysis of metal nanoparticles by atmospheric pressure chemical vapor deposition (APCVD) technique.
c) According to the invention a LIC and a method for making it is provided. The LIC comprises at least a Lithium-Ion electrode and an iCL-CNT electrode. Said electrodes, are placed in a container, are infiltrated with a Lithium electrolyte, are on one end separated by using a separator, and are on the other end connected on their current collectors-to each other, other electrodes, and/or circuits. A schematic drawing of the LIC is shown in FIG. 2.

### BRIEF DESCRIPTION OF THE FIGURES

FIG. 1 illustrates a single-side iCL-CNT electrode made of deposited cross-linked carbon nanotubes on the microstructured metal film substrate. (double-side iCL-CNT electrodes are not illustrated)

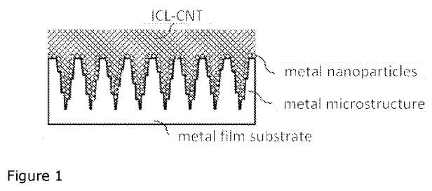

FIG. 2 illustrates a schematic drawing of a LIC according to the invention-negative graphite electrode, positive iCL-CNT electrode, Li-electrolyte, separator, cations, anions. The LIC is discharged. Anions and cations are dissolved in the electrolyte.

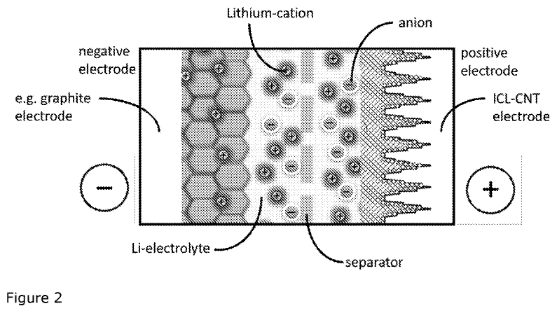

FIG. 3 illustrates a schematic drawing of a LIC according to the invention-negative graphite electrode, positive iCL-CNT electrode, Li-electrolyte, separator, cations, anions. The LIC is charged. Cations are intercalated in the negative electrode and anions forming an electric double layer (only the anions of the double layer are shown) at the positive electrode.

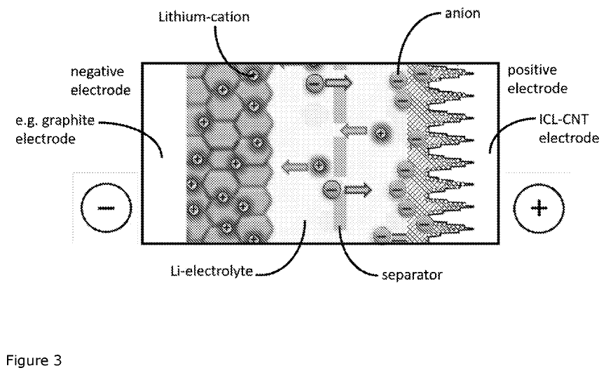

FIG. 4 illustrates a schematic drawing of a part of the iCL-CNT electrode, showing the anions forming an electric double layer at the interface between the electrolyte and the CNTs (only the anions of the double layer are shown).

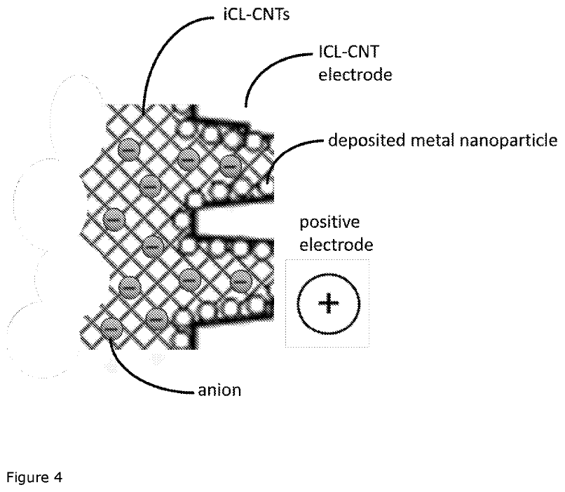

### DETAILED DESCRIPTION OF THE INVENTION

The important part and the most important feature of the present invention is the iCL-CNT electrode. In the following the process for fabricating the iCL-CNT electrode is provided. The process involves four steps: (1) forming metal microstructures on the metal film substrate; (2) depositing metal or metal compounds layer on the surface of metal microstructures; (3) converting metal or metal compounds layer into metal nanoparticles as the catalysts; (4) growing cross-linked carbon nanotubes on the metal microstructures in the presence of the catalysts.

In a preferred embodiment, aluminum foil, one of the typical metal film substrates, is used as the current collector. Before etching, aluminum foil is sequentially cleaned by deionized water, acetone, and isopropanol. Then, aluminum foil is performed surface alkali treatment by NaOH solution (1 mol/L) at 50˜60° C. for ca. 2-3 minutes. The etching time is one of the parameters to control the shape size and aspect ratio of aluminum microstructures on aluminum foil. For etching single-side aluminum microstructures, one side of aluminum foil is protected by tape and the other side is exposed to the mixed solution. As stated above this results in a microstructured surface having surface features with uniaxial open down to the substrate in the range of sub-microns to tens of microns deep and from submicron to microns wider at the top, preferably within the range of 0.5 to 50 microns deep depending on the thickness of the metal film substrate and 0.4 to 5 microns wide.

After etching aluminum foil, aluminum microstructures are deposited and coated with nickel nanoparticles. Nickel electron beam evaporation as a physical vapor deposition method is used. The etched aluminum foil is fixed in a vacuum chamber with a pressure of 5×10⁻⁷ to 1×10⁻⁶ Torr. The nickel atoms are simulated from nickel source by a constant current of 70-90 mA for the deposition time of 40 to 200 minutes. The electron beam deposition is performed under a pressure of 1×10⁻⁶ to 5×10⁻⁶ Torr with the argon flow of 10 sccm at the room temperature of 20-25° C. The deposited nickel on the microstructured aluminum foil will expose in the air atmosphere after taking from the vacuum chamber, resulting in the formation of nickel oxide on the aluminum microstructures.

Forming cross-linked carbon nanotubes, the microstructured aluminum foil deposited with nickel compounds is placed in the center of a tube furnace. The air in the tube furnace is pumped out and then filled with an Argon gas several times to reduce oxygen content. Then, 300-500 sccm of Ar and 50-150 sccm of H₂ is introduced into the tube to maintain atmospheric pressure. The tube furnace is heated up to 400-600° C. at the heating rate of 10° C. When the temperature reached to 400-600° C., 5-20 sccm C₂H₂ carbon-containing gas is introduced into the tube and held at the temperature of 400˜600° C. for 10 minutes to 2 hours. After that, C₂H₂, H₂, and Ar supply are shut off, and the tube furnace is cooled down to room temperature (25° C.) in a nitrogen atmosphere with a flow rate of 400 sccm. At the end of the APCVD process, the cross-linked carbon nanotubes are produced on the microstructured aluminum foil.

The Lithium intercalated negative electrode is fabricated as the negative electrode of a Lithium-Iron-Phosphate battery, by pre-lithiation of a porous graphite electrode. The Lithium containing material LiFePO4 in the negative porous carbon electrode are intercalated in the virgin electrode by wet processing with fine-grained powder dissolved in acetone. The solution is then exposed to the electrode in a vacuum process where the solution will be soaked into the pores when an inert gas is replacing the vacuum in the chamber with the electrode immersed in the solution. The solvent is then removed by an evaporation process by heating the electrode, and the fine-grained Lithium containing material remains intercalated in the pores.

The virgin intercalated negative electrode can then be used in the assembly of the LIC, where the iCL-CNT electrode and the negative electrode, are placed in a container, are infiltrated with the Lithium electrolyte, are on one end separated by the separator, and are on the other end connected on their current.

Other possible embodiments or parts of embodiments are described in the following and/or are described in the claims and/or are described in WO 2022/078759 A1:

The Lithium intercalated negative electrode can be fabricated as the negative electrode of a nickel-manganese-cobalt lithium battery, made by pre-lithiation of a porous carbon electrode. The Lithium containing material like LiNi0.33Mn0.33Co0.33O2 in the negative porous carbon electrode can be intercalated in the virgin electrode by different methods like wet processing with the material as fine-grained powder dissolved in a solvent like acetone or isopropanol. The solution is then exposed to the electrode in a vacuum process where the solution will be soaked into the pores when an inert gas is replacing the vacuum in the chamber with the electrode immersed in the solution. The solvent is then removed by an evaporation process by heating the electrode, and the fine-grained lithium containing material remains intercalated in the pores. The virgin intercalated negative electrode can then be used in the assembly of the LIC, placed in a container together with the positive iCL-CNT electrode, the infiltrated electrolyte and the separator.
[1] A. Jagadale, et al., Lithium-ion capacitors (LICs): Development of the materials, Energy Storage Materials (2019), doi https://doi.org/10.1016/j.ensm.2019.02.031
[2] WO2022/078759A1
[3] David Allart, et al., Model of Lithium Intercalation . . . Journal of The Electrochemical Society, Volume 165, Number 2.

1. Method for fabricating an electrode pair for a Lithium-Ion Capacitor (LIC), where the method comprises the steps of:
preparing the positive electrode by:
etching microstructures with a predetermined roughness in a surface of a metal film substrate,
depositing in said microstructures a metal or metal compound layer,
converting said metal or metal compound layer into metal nanoparticles,
growing interconnected cross linked carbon nanotubes in said microstructures at said metal nanoparticle,
preparing the negative electrode.

2. Method according to claim 1, where the metal film substrate comprises:
any type of metals, such as: aluminium, copper, nickel, titanium, chromium, or stainless steel, preferably aluminium.

3. Method according to claim 1, where depositing with the metal layer is be achieved by:
electroplating, electron-beam evaporation, thermal evaporation, or sputtering.

4. Method according to claim 3, where the metal layer comprises:
nickel, iron, cobalt, or a mixture of any of the above.

5. Method according to claim 1, where depositing of the metal compound layer can be achieved:
by dip coating or spray coating using a metal compound precursor.

6. Method according to claim 5, where the metal compounds precursor comprise:
nickel compound, iron compound, cobalt compound, or a mixture of any of the above.

7. Method according to claim 5, where the metal compound precursors can be prepared by:
dissolving the metal compounds into a soluble solvent, such as: water, methanol, ethanol, acetone, diethyl ether, or ethyl acetate, etc.

8. Method according to claim 1, where converting metal or metal compound layer into metal nanoparticles is performed:
at 100-400° C. in a hydrogen atmosphere.

9. Method according to claim 8, where the formed metal nanoparticles comprise:
nickel nanoparticles, iron nanoparticles, cobalt nanoparticles, or a mixture of any of the above.

10. Method according to claim 1, where growing interconnected cross-linked carbon nanotubes is formed:
by the catalytic pyrolysis of a carbon-containing gas by Atmospheric Pressure Chemical Vapor Deposition (APCVD) at 400-600°C.

11. Method according to claim 10, where the carbon-containing gases comprise:
acetylene, methane, ethylene, propane, butane, or a mixture of any of the above.

12. Method according to claim 1, where the metal film substrate comprises:
any structural type of metal products, such as: flat metal foil; or porous metal foil.

13. Method according to claim 1, where the metal film substrate with microstructures is be fabricated by:
a physical or chemical method.

14. Method according to claim 1, where the interconnected cross-linked carbon nanotubes comprise:
at least one of the following:
single-walled carbon nanotubes (SWCNTs); and
multi-walled carbon nanotubes (MWCNTs).

15. Method according to claim 1, where the interconnected cross-linked carbon nanotubes can be acted as a scaffold structure for loading with pseudocapacitive materials to form a pseudocapacitive electrode.

16. Method according to claim 15, where pseudocapacitive materials comprises:
transition metal oxides or conductive polymers.

17. Method according to claim 15, where transition metal oxides comprise:
at least one of manganese oxide, nickel oxide, cobalt oxide, and ruthenium oxide.

18. Method according to claim 15, where conductive polymers comprise:
at least one of polyaniline, polypyrrole, and poly(3,4-ethylenedioxythiophene), poly(4-styrenesulfonate)-(PEDOT, PSS).

19. Electrode pair for a Lithium-ion-Capacitor component,
where the electrode pair comprises a negative electrode and a positive electrode,
where the positive electrode is fabricated according to the method of the claim 1,
where the negative electrode is fabricated as the negative electrode of Lithium-ion-Battery.

20. Lithium-Ion Capacitor (LIC) comprising:
at least one negative and one positive electrode forming an electrode pair, where the at least one positive electrode being constituted according to the method of the claim 19,
a separator, and
an electrolyte.

21. Luthium-lon Capacitor according to claim 19 for use in electrical energy storage.
